(19) United States
(12) Patent Application Publication
(10) Pub. No.: US 2024/0399628 A1
(43) Pub. Date: Dec. 5, 2024

(54) METHOD FOR MANUFACTURING DAMPER MEMBER

(71) Applicant: NIDEC INSTRUMENTS CORPORATION, Nagano (JP)

(72) Inventor: Hiroto SUYAMA, Nagano (JP)

(21) Appl. No.: 18/675,165

(22) Filed: May 28, 2024

(30) Foreign Application Priority Data
May 31, 2023 (JP) 2023-089370

(51) Int. Cl. B29C 39/10; B29C 39/00; B29C 39/22; B29C 39/24; B29C 39/36; B29K 83/00; B29L 31/00

(52) U.S. Cl. CPC B29C 39/10; B29C 39/003; B29C 39/22; B29C 39/24; B29C 39/36; B29K 2083/00; B29K 2909/08; B29L 2031/721

(57) ABSTRACT

A method for manufacturing a damper member for connecting a movable body with a support body, the damper member including a viscoelastic body, a first sheet joined to one face of the viscoelastic body, and a second sheet joined to the other face of the viscoelastic body, includes assembling a spacer in a frame shape between the first sheet and the second sheet so as to surround around a space between the first sheet and the second sheet except a filling port, filling molding material for molding the viscoelastic body to the space through the filling port, and hardening the molding material and, while filling is performed, a voltage is applied between a first electrode contacted with one ends of the first sheet and the second sheet, and a second electrode contacted with the other ends of the first sheet and the second sheet and insulated from the first electrode.

### CROSS REFERENCE TO RELATED APPLICATION

The present invention claims priority under 35 U.S.C. § 119 to Japanese Application No. 2023-089370 filed May 31, 2023, the entire content of which is incorporated herein by reference.

### TECHNICAL FIELD

At least an embodiment of the present invention may relate to a method for manufacturing a damper member which connects a movable body with a support body.

### BACKGROUND

In Japanese Patent Laid-Open No. 2020-45996 (Patent Literature 1), as a device for generating vibration by a magnetic drive mechanism, an actuator is described in which a support body where a coil is disposed and a movable body where a permanent magnet is disposed are connected with each other through a damper member. A viscoelastic body such as silicone gel is used as the damper member. Silicone gel itself has an adsorption property and thus, it is difficult to handle it. Therefore, in Patent Literature 1, a structure is described in which thin sheets are joined to surfaces of silicone gel, and the viscoelastic body is connected with a movable body and a support body through the sheets.

In Patent Literature 1, a sheet disposed on a surface of a damper member and a viscoelastic body such as silicone gel are adhesively bonded to each other through primer. Therefore, a sheet and a viscoelastic body capable of being used are limited to materials which are capable of being adhesively bonded through primer and thus, types of a sheet and a viscoelastic body capable of being used are limited.

### SUMMARY

In view of the problem described above, at least an embodiment of the present invention may advantageously provide a method for manufacturing a damper member capable of enhancing a degree of freedom in selecting types of a viscoelastic body and a sheet which can be used for manufacturing the damper member.

According to at least an embodiment of the present invention, there may be provided a method for manufacturing a damper member which connects a movable body with a support body. The damper member includes a viscoelastic body, a first sheet which is joined to one side face of the viscoelastic body and is connected with one of the support body and the movable body, and a second sheet which is joined to the other face of the viscoelastic body and is connected with the other of the support body and the movable body. The method includes an assembling step in which a spacer in a frame shape is disposed between the first sheet and the second sheet so as to surround around a space between the first sheet and the second sheet except a filling port, a filling step in which molding material for molding the viscoelastic body is filled to the space through the filling port, and a hardening step in which the molding material is hardened. While the filling step is performed, a voltage is applied between a first electrode, which is contacted with one end part of the first sheet and one end part of the second sheet, and a second electrode which is contacted with the other end part of the first sheet and the other end part of the second sheet and is insulated from the first electrode.

In at least an embodiment of the present invention, molding material is filled and hardened between two sheets and thereby, the damper member in which sheets are joined to both sides of the viscoelastic body is manufactured. In this case, the two sheets are contacted with a pair of electrodes which are mutually insulated, and a voltage is applied between the electrodes. As a result, a polar group (—COOH, —NH or the like) is generated on a surface of the sheet by the voltage applied to the sheet. The polar group is reacted with a reactive group (—OH or the like) included in the molding material to form a chemical bond and thus, even when primer is not applied to the sheet, the hardened viscoelastic body and the sheet are directly joined to each other, and the sheet is not separated from the viscoelastic body. Therefore, primer is not necessary, and the sheet and the viscoelastic body are not required to limit to types compatible with the primer. Accordingly, a degree of freedom in selecting types of the viscoelastic body and a sheet which are capable of being used for manufacturing the damper member can be enhanced.

In this embodiment, it is preferable that, while the hardening step is performed, the voltage is applied between the first electrode and the second electrode. When the voltage is also applied during the hardening step in addition to the filling step, formation of the polar group on the surface of the sheet and a chemical bond between the reactive group and the polar group can be promoted also during the hardening step. Therefore, insufficient joining strength of the viscoelastic body to the sheet due to insufficient formation of the polar group can be avoided.

In this embodiment, it is preferable that the first electrode and the second electrode are provided in the spacer. For example, it is preferable that the spacer includes a first frame part and a second frame part, which are provided in a direction along the first sheet and the second sheet and face each other across the space, and a third frame part which connects an end part of the first frame part with an end part of the second frame part. The first electrode is provided in the first frame part, and the second electrode is provided in the second frame part, and the third frame part is made of an insulator. As described above, when an electrode is provided in the spacer which is used as a mold member for molding, the electrode contacting with the sheet can be easily provided. Further, the electrode can be provided so as to face across the space for molding and thus, the voltage can be applied to the entire sheet contacting with the molding material. Therefore, the sheet can be joined to the entire range of the surface of the viscoelastic body so as not to be separated.

In this embodiment, it is preferable that, in the assembling step, the spacer is sandwiched between a first mold member on a surface of which the first sheet is disposed and a second mold member on a surface of which the second sheet is disposed. According to this structure, flexible sheets can be supported by the mold members and thus, the space having a predetermined dimension can be formed. Therefore, the viscoelastic body can be molded in a predetermined thickness, and the damper member whose surfaces are joined with thin sheets can be manufactured.

In this embodiment, it is preferable that, after the molding material is hardened, a releasing step is performed in which the first mold member, the second mold member and the spacer are detached, and then, a cutting step is performed in which the viscoelastic body is cut together with the first sheet and the second sheet. According to this method, when the cutting step is performed after the viscoelastic body is molded between large-sized sheets, a large number of the damper members can be efficiently manufactured.

In this embodiment, it is preferable that the viscoelastic body is made of silicone rubber. Silicone rubber is formed of molding material (rubber material) provided with a reactive group and thus, the silicone rubber can be directly joined to a sheet provided with a polar group. Further, in a case that silicone rubber is used as the damper member, the silicone rubber is provided with characteristics suitable for restraining resonance.

Further, according to at least another embodiment of the present invention, there may be provided a method for manufacturing a damper member which connects a support body with a movable body. The damper member includes a viscoelastic body and a first sheet which is joined to one side face of the viscoelastic body and is connected with one of the support body and the movable body. The method includes an assembling step in which a forming mold is assembled so that the first sheet is disposed on an inner face of the forming mold, a filling step in which molding material for molding the viscoelastic body is filled in the forming mold, and a hardening step in which the molding material is hardened. While at least a part of the filling step and the hardening step is performed, a voltage is applied between a first electrode which is contacted with one end part of the first sheet and a second electrode which is contacted with the other end part of the first sheet and is insulated from the first electrode.

### EFFECTS OF THE INVENTION

According to the embodiment of the present invention, a sheet contacted with molding material at the time of molding is contacted with a pair of electrodes which are mutually insulated, and a voltage is applied between the electrodes. As a result, a polar group (—COOH, —NH or the like) is generated on a surface of the sheet by the voltage applied to the sheet. The polar group is reacted with a reactive group (—OH or the like) included in the molding material to form a chemical bond and thus, even when primer is not applied to the sheet, the hardened viscoelastic body and the sheet are directly joined to each other, and the sheet is not separated from the viscoelastic body. Therefore, primer is not necessary, and the sheet and the viscoelastic body are not required to limit to types compatible with the primer. Accordingly, a degree of freedom in selecting types of the viscoelastic body and a sheet which are capable of being used for manufacturing the damper member can be enhanced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outward perspective view showing an actuator.

FIG. 2 is the “Y-Z” cross-sectional view showing an actuator.

FIG. 3 is an exploded perspective view showing an actuator.

FIG. 4 is an exploded perspective view showing an actuator from which a case is removed.

FIG. 5 is an exploded perspective view showing a support body from which a case is removed.

FIG. 6 is a perspective view showing a damper member.

FIG. 7 is an explanatory view showing a device for manufacturing a damper member.

FIG. 8 is an explanatory view showing steps for manufacturing a damper member.

### DETAILED DESCRIPTION

A method for manufacturing a damper member in accordance with an embodiment of the present invention will be described below with reference to the accompanying drawings.

### Actuator

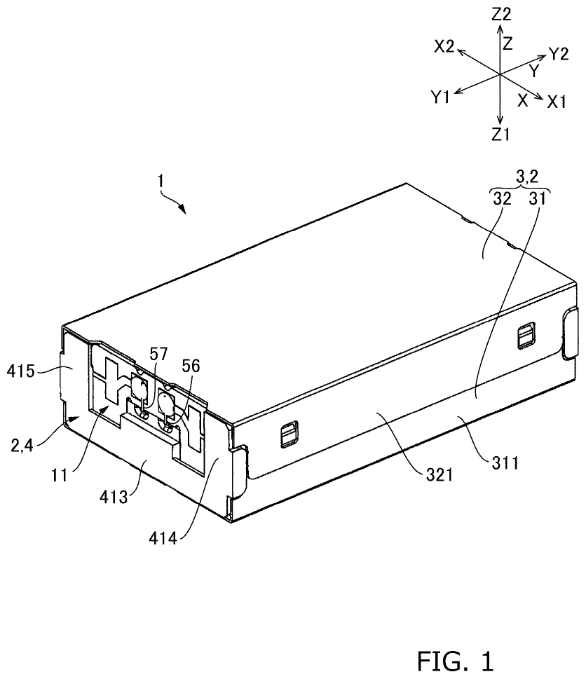

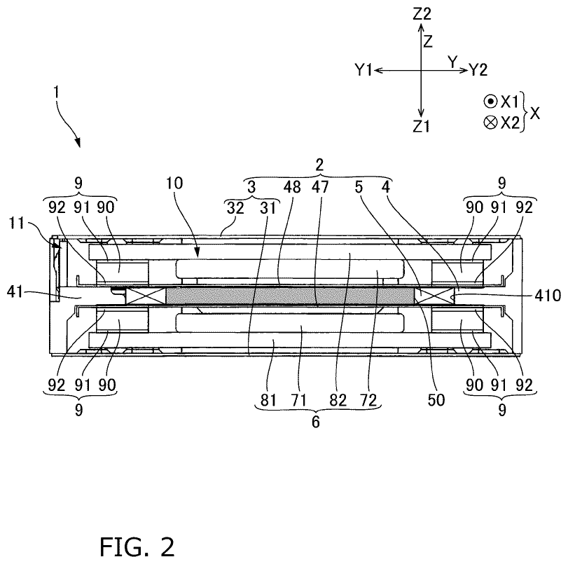

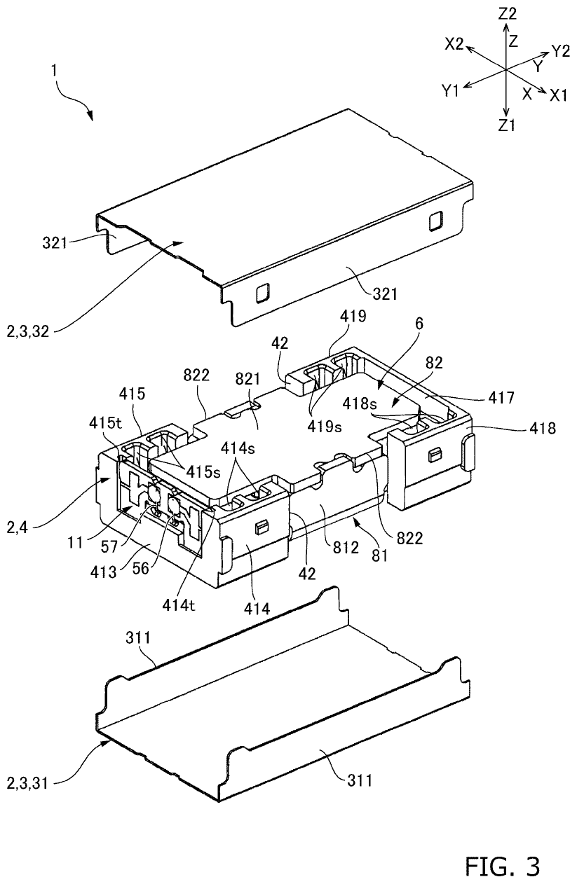

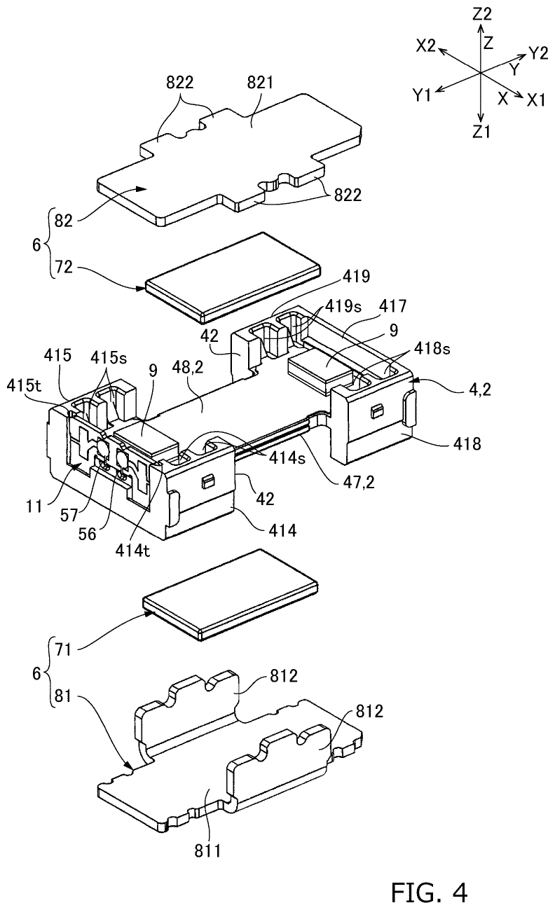

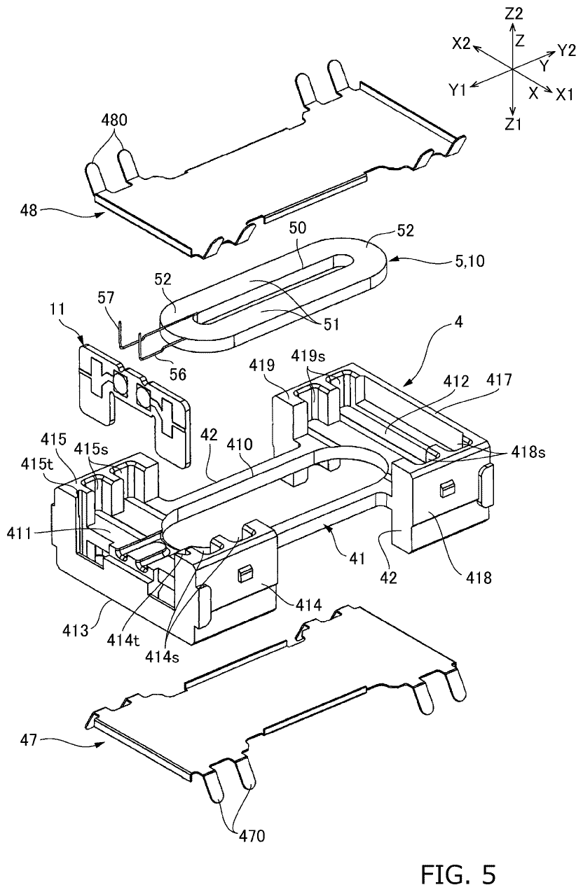

Structure of an actuator 1 including a damper member 9 will be described below with reference to FIGS. 1 through 5. FIG. 1 is an outward perspective view showing an actuator 1. FIG. 2 is the “Y-Z” cross-sectional view showing the actuator 1. FIG. 3 is an exploded perspective view showing the actuator 1. FIG. 4 is an exploded perspective view showing the actuator 1 from which a case 3 is removed. FIG. 5 is an exploded perspective view showing a support body 2 from which a case 3 is removed. An actuator 1 includes a support body 2 having a case 3, a movable body 6, damper members 9 which connect the movable body 6 with the support body 2, and a magnetic drive mechanism 10. The movable body 6 is supported by the support body 2 through the damper members 9.

In the present specification, three directions, i.e., a first direction “Z”, a second direction “X” and a third direction “Y” are directions perpendicular to each other. The second direction “X” is coincided with a moving direction (vibration direction) of the movable body 6. One side in the second direction “X” is referred to as an “X1” direction, the other side in the second direction “X” is referred to as an “X2” direction, one side in the first direction “Z” is referred to as a “Z1” direction, the other side in the first direction “Z” is referred to as a “Z2” direction, one side in the third direction “Y” is referred to as a “Y1” direction, and the other side in the third direction “Y” is referred to as a “Y2” direction.

As shown in FIG. 1, an actuator 1 is formed in a rectangular parallelepiped shape whose longitudinal direction is directed in the third direction “Y”. As shown in FIG. 2, a movable body 6 is accommodated in an inside of a case 3 and vibrates in the second direction “X” with respect to the support body 2. A user who holds the actuator 1 receives reaction force corresponding to vibration of the movable body 6 through the damper members 9 and the support body 2. Therefore, the actuator 1 is capable of outputting information by vibrating the movable body 6 to make a user bodily sense a new feeling. The actuator 1 is, for example, utilized as an operation member of a game machine or the like.

The support body 2 includes a case 3, a coil holder 4, a coil 5 and a power feeding board 11. As shown in FIG. 5, the coil 5 is an air core coil in an elliptical shape and is held in a coil arrangement hole 410 formed in the coil holder 4. As shown in FIGS. 1 and 3, in the support body 2, the case 3 includes a first case member 31 which is overlapped with the coil holder 4 from the “Z1” direction side and a second case member 32 which is overlapped with the coil holder 4 from the “Z2” direction side. A pair of side plate parts 311 of the first case member 31 which are provided on both sides in the second direction “X” are respectively connected with a pair of side plate parts 321 of the second case member 32 which are provided on both sides in the second direction “X” to structure the case 3.

As shown in FIG. 2, the movable body 6 includes a first yoke 81 which is made of a magnetic plate located on the “Z1” direction side with respect to the coil 5, and a first permanent magnet 71 in a flat plate shape which is held on a “Z2” direction side face of the first yoke 81. Further, the movable body 6 includes a second yoke 82 which is made of a magnetic plate located on the “Z2” direction side with respect to the coil 5, and a second permanent magnet 72 in a flat plate shape which is held on a “Z1” direction side face of the second yoke 82.

As shown in FIGS. 3 and 4, the first yoke 81 is provided with a flat plate part 811 to which the first permanent magnet 71 is fixed, and a pair of connecting parts 812 which are bent from both ends in the second direction “X” of the flat plate part 811 to the “Z2” direction side. A pair of the connecting parts 812 is extended in the first direction “Z” on both sides in the second direction “X” of the plate part 41 of the coil holder 4 in which the coil 5 is held. The second yoke 82 is provided with a flat plate part 821 to which the second permanent magnet 72 is fixed, and a pair of projecting parts 822 which project to both sides in the second direction “X” from an intermediate portion in the third direction “Y” of the flat plate part 821. A pair of the projecting parts 822 is connected with a pair of the connecting parts 812 of the first yoke 81 by a method such as welding.

The coil 5 disposed in the support body 2 and the permanent magnets (first permanent magnet 71 and second permanent magnet 72) which are disposed in the movable body 6 structure a magnetic drive mechanism 10 for relatively moving the movable body 6 with respect to the support body 2. In the actuator 1 in this embodiment, as described above, the coil 5 is disposed in the support body 2 and the permanent magnet is disposed in the movable body 6. However, arrangement of the coil 5 and the permanent magnet may be reversed.

Each of the first permanent magnet 71 and the second permanent magnet 72 is magnetized so that a pole of its “Z1” direction side portion and a pole of its “Z2” direction side portion are different from each other. As shown in FIG. 5, the coil 5 is provided with two long side parts 51 which are extended in the third direction “Y” and in parallel with each other in the second direction “X”, and two short side parts 52 in a circular arc shape which connect both ends in the third direction “Y” of the two long side parts 51. The long side part 51 of the coil 5 faces the first permanent magnet 71 which is held by the first yoke 81 on the “Z1” direction side and faces the second permanent magnet 72 which is held by the second yoke 82 on the “Z2” direction side. Therefore, the magnetic drive mechanism 10 generates a drive force for vibrating the movable body 6 in the second direction “X”.

As shown in FIG. 5, the coil holder 4 is provided with a plate part 41 which is formed with a coil arrangement hole 410. The plate part 41 is provided with a pair of cut-out parts 42 which are formed by cutting out center portions in the third direction “Y” at edges on both sides in the second direction “X” toward a center in the second direction “X”. The connecting part 812 of the yoke is disposed in each of the cut-out parts 42 (see FIG. 3).

On the “Y1” direction side with respect to a pair of the cut-out parts 42, a side plate part 413 extended in the second direction “X” and side plate parts 414 and 415 which are connected with both ends of the side plate part 413 and extended in the third direction “Y” are protruded in the first direction “Z” from an outer peripheral edge of an end part 411 on the “Y1” direction side of the plate part 41. Further, on the “Y2” direction side with respect to the cut-out parts 42, a side plate part 417 extended in the second direction “X” and side plate parts 418 and 419 which are connected with both ends of the side plate part 417 and extended in the third direction “Y” are protruded in the first direction “Z” from an outer peripheral edge of an end part 412 on the “Y2” direction side of the plate part 41.

Inner faces of the side plate parts 414 and 415 are formed with groove-shaped recessed parts 414s and 415s which are extended in the first direction “Z”. Similarly, inner faces of the side plate parts 418 and 419 are formed with groove-shaped recessed parts 418s and 419s which are extended in the first direction “Z”. The recessed parts 414s and 415s and the recessed parts 418s and 419s are respectively formed in the respective inner faces which are located on the “Z1” direction side and the “Z2” direction side with respect to the plate part 41.

A power feeding board 11 is held by a side face in the “Y1” direction side of the coil holder 4 by inserting both end parts in the second direction “X” of the power feeding board 11 into slits 414t and 415t which are formed in end parts on the “Y1” direction side of the side plate parts 414 and 415. The power feeding board 11 is connected with end parts 56 and 57 (see FIG. 5) of a coil wire structuring the coil 5 by soldering.

As shown in FIGS. 2, 4 and 5, the support body 2 includes a first plate 47 overlapped with the coil 5 and the plate part 41 from the “Z1” direction side and a second plate 48 which is overlapped with the coil 5 and the plate part 41 from the “Z2” direction side. The coil 5 is fixed to the first plate 47, the second plate 48 and the plate part 41 by an adhesive which is filled in an air core part 50 of the coil 5. The first plate 47 and the second plate 48 are made of nonmagnetic material. For example, the first plate 47 and the second plate 48 are made of a nonmagnetic stainless steel plate. Therefore, magnetic flux of the permanent magnet interlinks with the coil 5 without being affected by the first plate 47 and the second plate 48.

The first plate 47 is provided with claw parts 470 obliquely protruded from both ends in the second direction “X” to the “Z1” direction side. The claw parts 470 are elastically contacted with insides of the groove-shaped recessed parts 414s, 415s, 418s and 419s which are formed in the side plate parts 414, 415, 418 and 419 and held by the coil holder 4. The second plate 48 is provided with claw parts 480 obliquely protruded from both ends in the second direction “X” to the “Z2” direction side. The claw parts 480 are elastically contacted with insides of the groove-shaped recessed parts 414s, 415s, 418s and 419s which are formed in the side plate parts 414, 415, 418 and 419 and held by the coil holder 4.

### Damper Member

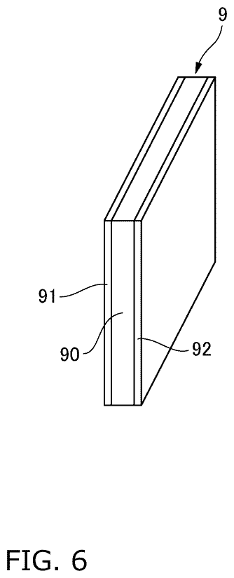

FIG. 6 is a perspective view showing a damper member 9. As shown in FIGS. 2 and 6, the damper member 9 includes a viscoelastic body 90, a first sheet 91 joined to a face on one side of the viscoelastic body 90, and a second sheet 92 which is joined to a face on the other side of the viscoelastic body 90. As shown in FIG. 2, the first sheet 91 of the damper member 9 is contacted with the movable body 6, and the second sheet 92 is contacted with the support body 2. The first sheet 91 is adhesively bonded to the movable body 6 and the second sheet 92 is adhesively bonded to the support body 2 and thereby, the movable body 6 and the support body 2 are connected with each other through the damper member 9.

As shown in FIG. 2, in this embodiment, the damper member 9 is disposed at a position where the first yoke 81 and the first plate 47 face each other in the first direction “Z”. Further, the damper member 9 is disposed at a position where the second yoke 82 and the second plate 48 face each other in the first direction “Z”. In this embodiment, the damper member 9 is formed in a flat plate shape whose thickness direction is the first direction “Z”, and the first sheet 91 is disposed on a face on one side in the thickness direction and the second sheet 92 is disposed on a face on the other side in the thickness direction. The damper member 9 is disposed between the movable body 6 and the support body 2 in a state that the viscoelastic body 90 is compressed in the thickness direction.

In this embodiment, viscoelasticity is a property having both of viscosity and elasticity and is a property remarkably found in a polymer substance such as a gel state member, plastic and rubber. Therefore, as the viscoelastic body 90, the following materials may be used. In other words, various rubber materials such as natural rubber, diene-based rubber (for example, styrene butadiene rubber, isoprene rubber, butadiene rubber, chloroprene rubber and acrylonitrile butadiene rubber), non-diene-based rubber (for example, butyl rubber, ethylene propylene rubber, ethylene propylene diene rubber, urethane rubber, silicone rubber and fluorine-containing rubber) and thermoplastic elastomer, and their denatured materials.

In this embodiment, the viscoelastic body 90 is fluorine polymerization type silicone rubber. Alternatively, as the viscoelastic body 90, a gel state member such as silicone gel may be used. In this case, for example, silicone rubber or silicone gel whose penetration degree is from 90 to 110 degrees may be used. The penetration degree is, as prescribed in JIS-K-2207 and JIS-K-2220, a value indicating a depth of a needle of ¼ cone which is applied with a total load of 9.38 g at 25° C. and enters in five seconds, and the value is expressed by 1/10 mm unit, and the smaller the value is, the hardness is larger.

Each of the first sheet 91 and the second sheet 92 is a film-shaped sheet which is thinner than the viscoelastic body 90 and is provided with flexibility. Each of the first sheet 91 and the second sheet 92 is made of a plastic sheet, a metal sheet or a laminated sheet of a metal sheet and a plastic sheet. As a plastic sheet, for example, a sheet may be used which is made of polyethylene terephthalate (PET), biaxially oriented polypropylene (OPP), polyamide (PA), polyetheretherketone (PEEK), acrylic resin or the like.

The first sheet 91 and the second sheet 92 are joined to the viscoelastic body 90 by a chemical bond described below. The first sheet 91 and the second sheet 92 are cut together with the viscoelastic body 90 in a size which can be disposed at a position where the movable body 6 and the support body 2 face each other. Therefore, the first sheet 91 and the second sheet 92 have the same or substantially same size as the viscoelastic body 90.

### Operation of Actuator

In the actuator 1, when the coil 5 is supplied with electric power through the power feeding board 11, the movable body 6 is reciprocated in the second direction “X” by a drive force of the magnetic drive mechanism 10 including the coil 5, the first permanent magnet 71 and the second permanent magnet 72. A user who holds the actuator 1 is capable of bodily sensing a feeling depending on vibration of the actuator 1 and obtaining information from the vibration.

In this case, a frequency and the like of a signal waveform of a drive signal applied to the coil 5 is controlled depending on vibration with which a user is to be bodily sensed. Further, polarity of a signal waveform is reversed and, in this case, a voltage can be changed in a slow and quick manner in the polarity of a negative period and a positive period. For example, acceleration when the movable body 6 is moved to the “X1” side and acceleration when the movable body 6 is moved to the other side “X2” in the second direction “X” are made different from each other. As a result, a user is capable of bodily sensing a feeling so as to move to the “X1” direction side or to the “X2” direction side.

The damper member 9 is disposed at a position where the support body 2 and the movable body 6 face each other in the first direction “Z” which is perpendicular to the vibration direction of the movable body 6. Therefore, when the movable body 6 is vibrated in the second direction “X”, the viscoelastic body 90 is deformed in a shearing direction and a resonance is prevented. In this embodiment, the viscoelastic body 90 is provided between the movable body 6 and the support body 2 in a compressed state and thus, the viscoelastic body 90 surely follows movement of the movable body 6.

The viscoelastic body 90 is provided with linear or nonlinear expansion and contraction characteristics depending on its expansion and contraction direction. For example, the viscoelastic body 90 is provided with expansion and contraction characteristics whose non-linear component is larger than a linear component when it is pressed in its thickness direction and is compressed and deformed. On the other hand, the viscoelastic body 90 is provided with expansion and contraction characteristics whose linear component is larger than a non-linear component when it is pulled and extended in its thickness direction. Therefore, in the viscoelastic body 90, when the movable body 6 is vibrated in the second direction “X”, a spring force in the moving direction becomes constant. Accordingly, reproducibility of vibrational acceleration with respect to an input signal can be improved and thus, vibration with a fine nuance can be realized.

### Method for Manufacturing Damper Member

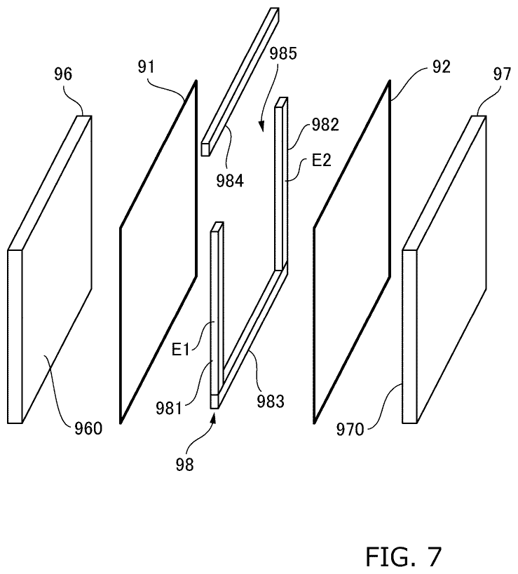

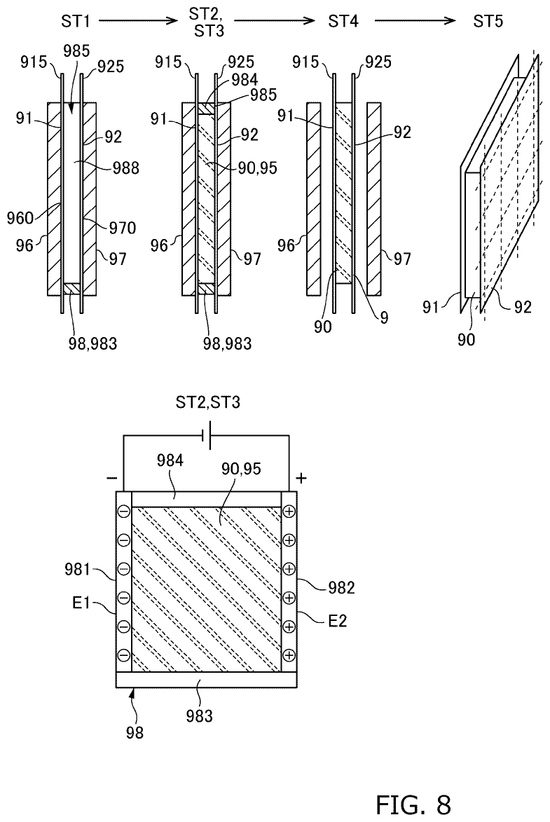

FIG. 7 is an explanatory view showing a device for manufacturing the damper member 9. FIG. 8 is an explanatory view showing steps for manufacturing the damper member 9. When the damper member 9 is to be manufactured, the damper member 9 may be manufactured in a size capable of being assembled into the actuator 1, or may be manufactured in a larger size than the size assembled into the actuator 1 and, after that, cutting is performed. In the following descriptions, the latter method (an embodiment in which the damper member 9 is cut in a size capable of being assembled into the actuator 1) will be described. However, the “damper member 9”, the “first sheet 91”, the “second sheet 92” and the “viscoelastic body 90” are described in the following descriptions regardless of the size.

As shown in FIGS. 7 and 8, a device for manufacturing the damper member 9 includes a first mold member 96, a spacer 98 and a second mold member 97. The first mold member 96 and the second mold member 97 are made of a glass plate or the like and are formed in a flat plate shape. The spacer 98 is formed in a frame shape and includes a first frame part 981 and a second frame part 982 which are disposed with a predetermined space therebetween, and a third frame part 983 which connects end parts of the first frame part 981 and the second frame part 982 with each other. In the embodiment shown in FIG. 7, the first frame part 981 and the second frame part 982 are formed in a straight line shape and are extended in parallel with each other. The third frame part 983 is extended in a direction perpendicular to the first frame part 981 and the second frame part 982.

The device for manufacturing the damper member 9 includes a first electrode “E1” (first frame part 981) which is contacted with one ends of the first sheet 91 and the second sheet 92, and a second electrode “E2” (second frame part 982) which is contacted with the other ends of the first sheet 91 and the second sheet 92 and are insulated from the first electrode “E1”. The first electrode “E1” and the second electrode “E2” are connected with power source terminals of different poles.

In this embodiment, the first electrode “E1” and the second electrode “E2” are provided in the spacer 98. In FIGS. 7 and 8, an embodiment is shown in which the first electrode “E1” is provided in the first frame part 981, the second electrode “E2” is provided in the second frame part 982, and the third frame part 983 is structured of an insulation member. For example, in each of the first frame part 981 and the second frame part 982, a portion contacting with the first sheet 91 and a portion contacting with the second sheet 92 are made of conductive material such as metal.

Steps for manufacturing the damper member 9 include, as shown in FIG. 8, an assembling step “ST1”, a filling step “ST2”, a hardening step “ST3”, a releasing step “ST4” and a cutting step “ST5”. First, in the assembling step “ST1”, a first mold member 96 whose surface 960 is arranged with the first sheet 91 and a second mold member 97 whose surface 970 is arranged with the second sheet 92 are assembled in a state that the spacer 98 is sandwiched between the first mold member 96 and the second mold member 97. In this case, for example, a volatile organic solvent is applied between the first mold member 96 and the first sheet 91, and between the second mold member 97 and the second sheet 92. As a result, the first mold member 96 and the first sheet 91 adhere to each other and the second mold member 97 and the second sheet 92 adhere to each other by surface tension of the organic solvent.

In the assembling step “ST1”, the spacer 98 is set in a state that the spacer 98 surrounds around a space 988 between the first sheet 91 and the second sheet 92 except a filling port 985. This state is maintained by tightening the first mold member 96 and the second mold member 97 from both sides by using a restraint member (not shown) and making the first sheet 91 and the second sheet 92 adhere to the spacer 98. As shown in FIG. 8, the spacer 98 is structured so that the third frame part 93 is located at a lower end and a portion between end parts of the first frame part 981 and the second frame part 982 on an opposite side to the third frame part 983 is the filling port 985 which is opened to an upper side. An end part 915 of the first sheet 91 and an end part 925 of the second sheet 92 are extended to an upper side with respect to the filling port 985 of the spacer 98.

In the filling step “ST2”, molding material 95 before being hardened is filled into the space 988 from a portion between the end part 915 of the first sheet 91 and the end part 925 of the second sheet 92 through the filling port 985. After that, the filling port 985 is closed by an upper plate 984. In this embodiment, silicone rubber is molded as the viscoelastic body 90. Therefore, liquid rubber material is filled into the space 988 as the molding material 95.

As described above, in this embodiment, various materials may be used as the viscoelastic body 90. In a case that, a gel state member such as silicone gel is to be molded as the viscoelastic body 90, gel material is filled in the space 988 as the molding material 95. As the molding material 95, two-liquid mixed type molding material having a room-temperature hardening property or heat curing type molding material may be used. Alternatively, an addition reaction type or a condensation reaction type molding material may be used.

As shown in FIG. 8, the filling step “ST2” is performed while a predetermined voltage is applied to the first sheet 91 and the second sheet 92 through the first electrode “E1” (first frame part 981) and the second electrode “E2” (second frame part 982) which are insulated from each other. For example, the filling step “ST2” is performed while a high frequency not less than 40 kHz and high voltage is applied to the first sheet 91 and the second sheet 92.

In the hardening step “ST3”, the molding material 95 is hardened to make the viscoelastic body 90. In a case that the molding material 95 has a thermosetting property, the molding material 95 is cured while heated through the first mold member 96 and the second mold member 97. In a case that the molding material 95 has a room-temperature hardening property, the molding material 95 is hardened at a room temperature without being heated. In each case, while the hardening step “ST3” is performed, the organic solvent is evaporated and released from between the first mold member 96 and the first sheet 91 and between the second mold member 97 and the second sheet 92.

In this embodiment, in addition to the filling step “ST2”, the predetermined voltage is also applied to the first sheet 91 and the second sheet 92 through the first electrode “E1” and the second electrode “E2” while the hardening step “ST3” is performed. When a high frequency and high voltage as described above is applied to the first sheet 91 and the second sheet 92, a polar group (for example, —COOH, —NH, >C═O, —COH or the like) is generated on surfaces of the first sheet 91 and the second sheet 92. Therefore, a chemical bond is formed between the generated polar group and a reactive group (for example, —OH) which is included in the molding material 95, and the first sheet 91 and the second sheet 92 are joined to the surfaces of the viscoelastic body 90.

In the releasing step “ST4”, the first mold member 96, the second mold member 97 and the upper plate 984 are removed, and the viscoelastic body 90 is detached from the spacer 98. In this embodiment, when a portion of the spacer 98 facing the space 988 (in other words, a portion which is contacted with the molding material 95) is made of fluororesin such as tetrafluoroethylene resin, the viscoelastic body 90 can be easily detached in the releasing step “ST4”.

In the cutting step “ST5”, the damper member 9 is cut in a predetermined size suitable for connecting the movable body 6 with the support body 2 in the actuator 1.

### Principal Effects in This Embodiment

As described above, the damper member 9 for connecting the movable body 6 with the support body 2 of the actuator 1 includes the viscoelastic body 90, the first sheet 91 which is joined to one side face of the viscoelastic body 90 and is connected with one of the support body 2 and the movable body 6, and the second sheet 92 which is joined to the other face of the viscoelastic body 90 and is connected with the other of the support body 2 and the movable body 6. This embodiment relates to a method for manufacturing the above-mentioned damper member 9, and the following steps are performed. In other words, the assembling step “ST1” in which the frame-shaped spacer 98 is arranged between the first sheet 91 and the second sheet 92 so as to surround the space 988 between the first sheet 91 and the second sheet 92 except the filling port 985, the filling step “ST2” in which the molding material 95 for molding the viscoelastic body 90 is filled into the space 988 through the filling port 985, and the hardening step “ST3” in which the molding material 95 is hardened. While the filling step “ST2” is performed, a voltage is applied between the first electrode “E1”, which is contacted with one end part of the first sheet 91 and one end part of the second sheet 92, and the second electrode “E2” which is contacted with the other end part of the first sheet 91 and the other end part of the second sheet 92 and is insulated from the first electrode “E1”.

In the manufacturing method in this embodiment, molding material 95 is filled and hardened between two sheets (first sheet 91 and second sheet 92) and thereby, the damper member 9 in which sheets are joined to both sides of the viscoelastic body 90 is manufactured. In this case, the two sheets are contacted with a pair of electrodes (first electrode “E1” and second electrode “E2”) which are mutually insulated, and a voltage is applied between the electrodes. As a result, a polar group (—COOH, —NH or the like) is generated on a surface of the sheet. The polar group is reacted with a reactive group (—OH or the like) included in the molding material 95 to form a chemical bond. Therefore, even when primer is not applied to the sheet, the hardened viscoelastic body 90 and the sheet are directly joined to each other and thus, the sheet is not separated from the viscoelastic body 90. Accordingly, primer is not necessary, and the sheet and the viscoelastic body 90 are not required to limit to types compatible with the primer. Therefore, a degree of freedom in selecting types of the viscoelastic body 90 and a sheet (first sheet 91 and second sheet 92) which are capable of being used for manufacturing the damper member 9 can be enhanced.

In this embodiment, the voltage is also applied during the hardening step “ST3” in addition to the filling step “ST2”. As a result, formation of the polar group on the surface of the sheet and a chemical bond between the reactive group and the polar group can be also promoted during the hardening step “ST3”. Therefore, insufficient joining strength of the viscoelastic body 90 to the sheet due to insufficient formation of the polar group can be avoided. In accordance with an embodiment of the present invention, a time period during which a voltage is applied may be a part of a time period from a start of the filling step “ST2” to an end of the hardening step “ST3”.

In this embodiment, the first electrode “E1” and the second electrode “E2” are provided in the spacer 98. For example, the spacer 98 is a frame-shaped member which includes the first frame part 981 and the second frame part 982, which are provided in a direction along the first sheet 91 and the second sheet 92 and face each other across the space 988, and the third frame part 983 which connects end parts of the first frame part 981 and the second frame part 982 with each other. The first electrode “E1” is provided in the first frame part 981, and the second electrode “E2” is provided in the second frame part 982. The third frame part 983 is made of an insulator. As described above, when an electrode is provided in the spacer 98 which is used as a mold member for molding, the electrode contacting with the sheet can be easily provided. Further, the electrodes can be disposed so as to face each other across the space 988 for molding and thus, the voltage can be applied to the entire ranges of the first sheet 91 and the second sheet 92 contacting with the molding material 95. Therefore, the first sheet 91 and the second sheet 92 can be joined to the entire range of the surface of the viscoelastic body 90 so as not to be separated.

In this embodiment, in the assembling step “ST1”, the spacer 98 is sandwiched between the first mold member 96 on the surface of which the first sheet 91 is disposed and the second mold member 97 on the surface of which the second sheet 92 is disposed. Therefore, flexible sheets can be supported by the mold members and thus, the space 988 having a predetermined dimension can be formed. Accordingly, the viscoelastic body 90 can be molded in a predetermined thickness, and the damper member 9 whose surfaces are joined with thin sheets can be manufactured.

In accordance with an embodiment of the present invention, a device for manufacturing the damper member 9 is not limited to the above-mentioned structure. In other words, a device for manufacturing the damper member 9 may be structured so that molding material 95 is filled and hardened in the space 988 between the first sheet 91 and the second sheet 92 and, during that time, electrodes are respectively connected with the first sheet 91 and the second sheet 92, and a voltage of a high frequency and high voltage can be applied between one end part and the other end part of the respective sheets.

In this embodiment, after the molding material 95 is hardened, the releasing step “ST4” in which the first mold member 96, the second mold member 97 and the spacer 98 are detached and the cutting step “ST5” in which the viscoelastic body 90 is cut together with the first sheet 91 and the second sheet 92 are performed. As described above, when the cutting step “ST5” is performed after the viscoelastic body 90 is molded between large-sized sheets, a large number of the damper members 9 can be efficiently manufactured.

In this embodiment, the viscoelastic body 90 is made of silicone rubber. Silicone rubber is formed of molding material 95 (rubber material) provided with a reactive group and thus, the silicone rubber can be directly joined to a sheet provided with a polar group. Further, in a case that silicone rubber is used as the damper member 9, the silicone rubber is provided with characteristics suitable for restraining resonance.

### Other Embodiments

The following embodiments may be adopted as an embodiment of the present invention.

(1) A method for manufacturing a damper member for connecting a movable body with a support body,
the damper member including:
   a viscoelastic body;
   a first sheet which is joined to one side face of the viscoelastic body and is connected with one of the support body and the movable body; and
   a second sheet which is joined to the other face of the viscoelastic body and is connected with the other of the support body and the movable body, the method including:
   an assembling step in which a spacer in a frame shape is disposed between the first sheet and the second sheet so as to surround around a space between the first sheet and the second sheet except a filling port;
   a filling step in which molding material for molding the viscoelastic body is filled to the space through the filling port; and
   a hardening step in which the molding material is hardened,
where while the filling step is performed, a voltage is applied between a first electrode, which is contacted with one end part of the first sheet and one end part of the second sheet, and a second electrode which is contacted with the other end part of the first sheet and the other end part of the second sheet and is insulated from the first electrode.
   (2) The method for manufacturing the damper member described in the above-mentioned method (1), where while the hardening step is performed, the voltage is applied between the first electrode and the second electrode.
   (3) The method for manufacturing the damper member described in the above-mentioned method (1) or (2), where the first electrode and the second electrode are provided in the spacer.
   (4) The method for manufacturing the damper member described in the above-mentioned method (3), where the spacer includes a first frame part and a second frame part, which are provided in a direction along the first sheet and the second sheet and face each other across the space, and a third frame part which connects an end part of the first frame part with an end part of the second frame part, the first electrode is provided in the first frame part, and the second electrode is provided in the second frame part, and the third frame part is made of an insulator.
   (5) The method for manufacturing the damper member described in one of the above-mentioned methods (1) through (4), where in the assembling step, the spacer is sandwiched between a first mold member on a surface of which the first sheet is disposed and a second mold member on a surface of which the second sheet is disposed.
   (6) The method for manufacturing the damper member described in the above-mentioned method (5), where after the molding material is hardened, a releasing step is performed in which the first mold member, the second mold member and the spacer are detached, and then, a cutting step is performed in which the viscoelastic body is cut together with the first sheet and the second sheet.
   (7) The method for manufacturing the damper member described in one of the above-mentioned methods (1) through (6), where the viscoelastic body is made of silicone rubber.

In the embodiments described above, the damper member is used which is structured of a viscoelastic body whose both sides are joined with sheets. However, a damper member may be used which is structured of a viscoelastic body whose one side is joined with a sheet. In this case, the damper member can be conveyed in a state that its face where a sheet is joined is sucked and thus, the damper member can be easily handled. A method for manufacturing the damper member which is structured of a viscoelastic body whose one side (one side face) is joined with a sheet (first sheet) may adopt the following embodiment (8). In this case, a forming mold in the following embodiment (8) may utilize the first mold member 96, the second mold member 97 and the spacer 98 described in the above-mentioned embodiment, or may utilize other structure.

(8) A method for manufacturing a damper member for connecting a support body with a movable body,
the damper member including:
   a viscoelastic body; and
   a first sheet which is joined to one side face of the viscoelastic body and is connected with one of the support body and the movable body;
the method including:
   an assembling step in which a forming mold is assembled so that the first sheet is disposed on an inner face of the forming mold,
   a filling step in which molding material for molding the viscoelastic body is filled in the forming mold; and
   a hardening step in which the molding material is hardened,
where while at least a part of the filling step and the hardening step is performed, a voltage is applied between a first electrode which is contacted with one end part of the first sheet and a second electrode which is contacted with the other end part of the first sheet and is insulated from the first electrode.

In the embodiment (8), similarly to the above-mentioned embodiments, it is preferable that the voltage is continuously applied from a start of the filling step until an end of the hardening step. Further, the viscoelastic body may be made of silicone rubber.

In the respective embodiments described above, the damper member is not limited to a plate-shaped member. For example, a cylindrical viscoelastic body whose inner peripheral face and outer peripheral face are joined with sheets may be utilized. Also in this embodiment, the viscoelastic body can be hardened while a high frequency and high voltage is applied to a sheet and joined to the sheet.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for manufacturing a damper member for connecting a movable body with a support body,
the damper member comprising:
a viscoelastic body;
a first sheet which is joined to one side face of the viscoelastic body and is connected with one of the support body and the movable body; and
a second sheet which is joined to an other face of the viscoelastic body and is connected with an other of the support body and the movable body, the method comprising:
an assembling step in which a spacer in a frame shape is disposed between the first sheet and the second sheet so as to surround around a space between the first sheet and the second sheet except a filling port;
a filling step in which molding material for molding the viscoelastic body is filled to the space through the filling port; and
a hardening step in which the molding material is hardened,
wherein while the filling step is performed, a voltage is applied between a first electrode, which is contacted with one end part of the first sheet and one end part of the second sheet, and a second electrode which is contacted with an other end part of the first sheet and an other end part of the second sheet and is insulated from the first electrode.

2. The method for manufacturing the damper member according to claim 1, wherein while the hardening step is performed, the voltage is applied between the first electrode and the second electrode.

3. The method for manufacturing the damper member according to claim 1, wherein the first electrode and the second electrode are provided in the spacer.

4. The method for manufacturing the damper member according to claim 3, wherein the spacer comprises:
a first frame part and a second frame part, which are provided in a direction along the first sheet and the second sheet and face each other across the space; and
a third frame part which connects an end part of the first frame part with an end part of the second frame part,
the first electrode is provided in the first frame part, and the second electrode is provided in the second frame part, and
the third frame part is made of an insulator.

5. The method for manufacturing the damper member according to claim 1, wherein in the assembling step, the spacer is sandwiched between a first mold member on a surface of which the first sheet is disposed and a second mold member on a surface of which the second sheet is disposed.

6. The method for manufacturing the damper member according to claim 5, wherein after the molding material is hardened, a releasing step is performed in which the first mold member, the second mold member and the spacer are detached, and then, a cutting step is performed in which the viscoelastic body is cut together with the first sheet and the second sheet.

7. The method for manufacturing the damper member according to claim 1, wherein the viscoelastic body is made of silicone rubber.

8. A method for manufacturing a damper member for connecting a support body with a movable body,
the damper member comprising:
a viscoelastic body; and
a first sheet which is joined to one side face of the viscoelastic body and is connected with one of the support body and the movable body;
the method comprising:
an assembling step in which a forming mold is assembled so that the first sheet is disposed on an inner face of the forming mold,
a filling step in which molding material for molding the viscoelastic body is filled in the forming mold; and
a hardening step in which the molding material is hardened,
wherein while at least a part of the filling step and the hardening step is performed, a voltage is applied between a first electrode which is contacted with one end part of the first sheet and a second electrode which is contacted with an other end part of the first sheet and is insulated from the first electrode.
